(19) United States
(12) Patent Application Publication
(10) Pub. No.: US 2019/0313327 A1
(43) Pub. Date: Oct. 10, 2019

(54) METHOD AND APPARATUS FOR VOICE DOMAIN SELECTION

(71) Applicant: MEDIATEK INC., Hsinchu (TW)

(72) Inventors: Chien-Chun HUANG-FU, Hsinchu (TW); Zong-Syun LIN, Hsinchu (TW)

(73) Assignee: MEDIATEK INC., Hsinchu (TW)

(21) Appl. No.: 16/372,133

(22) Filed: Apr. 1, 2019

Related U.S. Application Data
(60) Provisional application No. 62/655,137, filed on Apr. 9, 2018.
(60) Provisional application No. 62/660,281, filed on Apr. 20, 2018.

(51) Int. Cl. H04W 48/18; H04M 1/253; H04M 7/00; H04W 80/04; H04W 60/04; H04W 88/06

(52) U.S. Cl. CPC H04W 48/18; H04M 1/2535; H04M 7/0066; H04M 2207/20; H04W 60/04; H04W 88/06; H04W 80/04

(57) ABSTRACT

Aspects of the disclosure can provide an apparatus and method for voice domain selection (VDS). A processing circuitry of user equipment (UE) is configured to receive an indication that an internet protocol (IP) multimedia core network subsystem (IMS) voice is unsupported over a 3GPP access, but is supported over a non-3GPP access in a first communication system. Then, the processing circuitry is configured to register to an IMS via the non-3GPP access in the first communication system and perform an IMS voice service over the non-3GPP access in the first communication system. The processing circuitry of the UE is further configured to switch to a second communication system when voice domain management (VDM) is set to the second communication system. After registering to the first communication system using a non-3GPP access, and registering to the IMS via the non-3GPP access in the first communication system, the processing circuitry of the UE can be configured to switch back to the first communication system from the second communication system.

### INCORPORATION BY REFERENCE

This present disclosure claims the benefit of U.S. Provisional Application No. 62/655,137, “5GSM Enhancement on Interworking” filed on Apr. 9, 2018, and U.S. Provisional Application No. 62/660,281, “Enhanced PS Data Off Mechanism” filed on Apr. 20, 2018. The entire disclosures of the prior applications are incorporated herein by reference in its entirety.

### TECHNICAL FIELD

The present disclosure relates to voice domain selection (VDS) in mobile communications and more particularly, to enhancement of VDS in the fourth generation (4G) system and the fifth generation (5G) system.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

The mobile communication system has grown exponentially over the years. The 3^{rd} Generation Partnership Project (3GPP), which has developed the most successful standard technologies in mobile communication market, such as Universal Mobile Telecommunication System (UMTS) and the fourth generation (4G) Long Term Evolution (LTE) system, is currently carrying out the standardization of the fifth generation (5G) system which includes a core network and an access network. The access network can integrate different access types, e.g., 3GPP access and non-3GPP access. Specifically, a 3GPP access is a radio access technology (RAT) specified by 3GPP, and a non-3GPP access is an access technology that is not specified by 3GPP. The technologies for 3GPP access can include Global System for Mobile communications (GSM), UMTS, LTE, and the like. The technologies for non-3GPP access can include Wi-Fi, Code-Division Multiple Access 2000 (CDMA2000), Worldwide Interoperability for Microwave Access (WiMAX), Digital Subscriber Line (DSL), and the like.

Internet Protocol (IP) Multimedia Subsystem (IMS) is an architectural framework for delivering IP multimedia services (e.g., IMS voice service) over the mobile communication systems, such as 4G and 5G systems. Voice-centric user equipment (UE) can perform a voice domain selection (VDS) by selecting and engaging with a communication system from a plurality of communication systems that supports the IMS voice service and perform the IMS voice service. For example, a voice-centric UE can obtain the IMS voice service over a 3GPP access when the IMS voice is supported over the 3GPP access in the 4G or 5G system.

However, current 3GPP specification does not define other scenarios or conditions under which the UE can determine whether it can obtain the IMS voice service in the 4G or 5G system. Accordingly, when the IMS voice is not supported over the 3GPP access in the 4G or 5G system, then the UE can reselect and engage with a new communication system. For example, when the IMS voice in not supported over the 3GPP access in the 4G system, then the UE can switch from the 4G system to a 3G or 2G system. Similarly, when the IMS voice is not supported over the 3GPP access in the 5G system, then the UE can switch from the 5G system to a 4G, 3G, or 2G system. Undesirably, the switch from the one communication system to another can lower user experience and increase signaling overhead. In order to maintain a good user experience, the UE can stay in the 4G or 5G system when a non-3GPP access is available and use the non-3GPP access for the IMS voice service. Accordingly, the UE can perform the VDS by staying in the current communication system (4G or 5G system) and obtain the IMS voice service when the IMS voice is supported over the non-3GPP access.

### SUMMARY

Aspects of the disclosure provide user equipment (UE) for voice domain selection (VDS). The UE can include processing circuitry that is configured to receive an indication that an Internet Protocol (IP) Multimedia Subsystem (IMS) voice is unsupported over a 3GPP access, but is supported over a non-3GPP access in a first communication system, register to the first communication system using the non-3GPP access if the UE is not yet registered, register to an IMS via the non-3GPP access in the first communication system, and perform the IMS voice over the non-3GPP access in the first communication system.

In an embodiment, the processing circuitry can further switch to a second communication system when its voice domain management (VDM) is set to the second communication system, register to the first communication system using a non-3GPP access if the UE is not yet registered, register to the IMS via the non-3GPP access in the first communication system, and switch to the first communication system from the second communication system.

In an embodiment, when the first communication system is a fifth generation (5G) system and the second communication system can be one of: a fourth generation (4G) system; a third generation (3G) system; or a second generation (2G) system. When the first communication system is a 4G system and the second communication system can be one of: a 3G system or a 2G system.

When the first communication system is a fifth generation (5G) system, the processing circuitry can be further configured to remain in the 5G system, register to the non-3GPP access in the 5G system if the UE is not yet registered, register to the IMS over the non-3GPP access in the 5G system, and perform the IMS voice over the non-3GPP access in the first communication system.

In an embodiment, when the first communication system is a fourth generation (4G) system, the processing circuitry can be configured to remain in the 4G system, register to the 4G system using the non-3GPP access if the UE is not yet registered, register to the IMS over the non-3GPP access in the 4G system, and perform the IMS voice over the non-3GPP access in the first communication system.

In an embodiment, the processing circuitry performing the IMS voice over the non-3GPP access in the 4G system can further configured to select a Wi-Fi calling (WFC) for the IMS voice call when the VDM is set to Wi-Fi, and select a circuit switched fallback (CSFB) for a circuit switched (CS) voice call when the VDM is set to cellular.

Aspects of the disclosure further provide a method for voice domain selection (VDS), including receiving, by a processing circuitry of a UE, an indication that an IMS voice is unsupported over a 3GPP access, but is supported over a non-3GPP access in a first communication system, registering to the first communication system using the non-3GPP access if the UE is not yet registered, registering to an IMS via the non-3GPP access in the first communication system, and performing the IMS voice over the non-3GPP access in the first communication system.

Aspects of the disclosure further provide a method for voice domain selection, including switching, by a processing circuitry of a UE, to a second communication system when the VDM is set to the second communication system, registering to the first communication system using a non-3GPP access if the UE is not yet registered, registering to the IMS via the non-3GPP access in the first communication system, and switching to the first communication system from the second communication system.

Further embodiments of the disclosure further can provide a non-transitory computer readable medium storing instructions which, when executed by a processor, cause the processor to receive an indication that an IMS voice is unsupported over a 3GPP access, but is supported over a non-3GPP access in a first communication system, register to the first communication system using a non-3GPP access if the UE is not yet registered, register to an IMS via the non-3GPP access in the first communication system, and perform the IMS voice over the non-3GPP access in the first communication system.

Aspects of the disclosure can further provide a non-transitory computer readable medium storing instructions which, when executed by a processor, cause the processor to switch to a second communication system when the VDM is set to the second communication system, register to the first communication system using a non-3GPP access if the UE is not yet registered, register to the IMS via the non-3GPP access in the first communication system, and switch to the first communication system from the second communication system.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a communication system according to an exemplary embodiment of the disclosure;

FIG. 2 is a flowchart showing an exemplary voice domain selection process in a 4G system according to an embodiment of the disclosure;

FIG. 3 is a flowchart showing another exemplary voice domain selection process in a 4G system according to an embodiment of the disclosure;

FIG. 4 is a flowchart showing an exemplary voice domain selection process in a 5G system according to an embodiment of the disclosure;

FIG. 5 is a flowchart showing another exemplary voice domain selection process in a 5G system according to an embodiment of the disclosure; and

FIG. 6 shows an exemplary block diagram of a UE according to an embodiment of the disclosure.

### DETAILED DESCRIPTION OF EMBODIMENTS

Aspects of the disclosure provide a user equipment (UE) for voice domain selection (VDS) by selecting and engaging with a communication system from a plurality of communication systems including a first communication system and at least a second communication system. The first communication system can provide a higher data rate and a better user experience than the second communication system. For example, when the first communication system is a fifth generation (5G) system, then the second communication system can be a fourth generation (4G) system, third generation (3G) system, or second generation (2G) system. Similarly, when the first communication system is a 4G system, then the second communication system can be a 3G system or a 2G system.

In some examples, when Internet Protocol (IP) Multimedia Subsystem (IMS) voice is not supported over the 3GPP access in the first communication system, the UE can stay in the first communication when a non-3GPP access is available and obtain the IMS voice service over the non-3GPP access. Therefore, the UE can maintain the better data rate and the better user experience and avoid reselecting a new Radio Access Technology (RAT) to access to the second communication system, which can result in increased signaling overhead.

In some other examples, when the IMS voice is not supported over the 3GPP access in the first communication system, the UE can switch to a second communication system due to its voice domain management (VDM) setting. Further, the UE can switch back to the first communication system from the second communication system after the UE can register to the first communication system over the non-3GPP access when the non-3GPP access is available and the IMS voice is supported over the non-3GPP access in the first communication system. Therefore, the UE can regain the higher data rate and the better user experience in the first communication system.

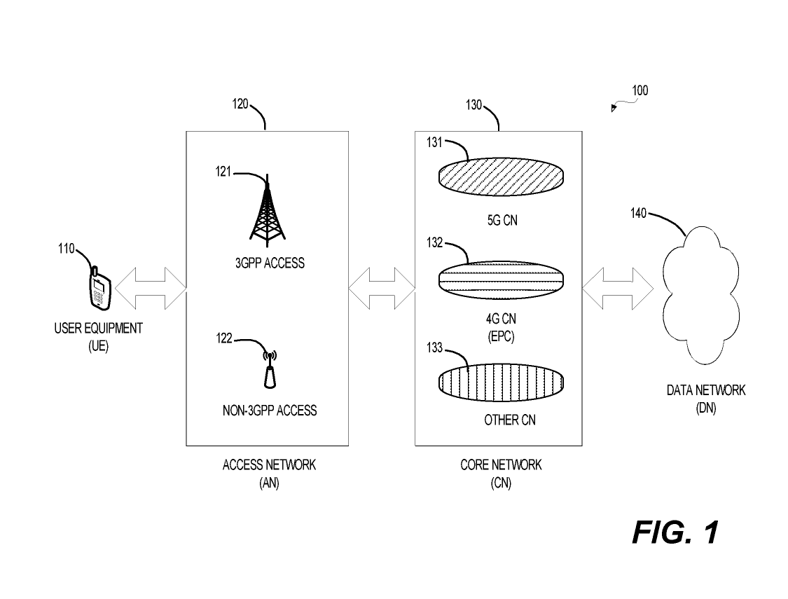

FIG. 1 shows an exemplary communication system 100 according to an embodiment of the disclosure. As shown, the communication system 100 can include a UE 110, an access network (AN) 120, a core network (CN) 130, and a data network (DN) 140.

The UE 110 can be any device or network element in the communication system 100 capable of signal transmission and reception. For example, the UE 110 can be a mobile phone, a laptop computer, a tablet, a vehicle carried mobile communication device, a utility meter fixed at a certain location, a commercial product with wireline or wireless communication capability, and the like. While only one UE 110 is depicted in the FIG. 1, it should be understood that any number of UEs 110 can be distributed in the system 100. In general, based on the UE's usage setting, the UE can behave in either a “voice centric” or “data-centric” way. The voice centric UE can register to an IMS for the IMS voice service, e.g., voice call. For purposes of clarity in this description, all of the UEs 110 in this disclosure can be assumed to be voice centric UEs 110.

The AN 120 is part of the communication system 100 that implements access technologies. It resides between the UE 110 and provides connection to the CN 130. In general, the access technologies implemented in the AN 120 can be categorized into two types: 3GPP access 121 and non-3GPP access 122. A 3GPP access 121 is a RAT specified by the 3GPP, and a non-3GPP access 122 is an access technology that is not specified by the 3GPP. Exemplary technologies for 3GPP access 121 can be Global System for Mobile communications (GSM), Universal Mobile Telecommunication System (UMTS), Long Term Evolution (LTE), 5G New Radio (NR) and the like. Exemplary technologies for non-3GPP access 122 can be Wi-Fi, Code-Division Multiple Access 2000 (CDMA2000), Worldwide Interoperability for Microwave Access (WiMAX), Digital Subscriber Line (DSL), and the like.

The CN 130 is another part of the communication system 100 that provides service management and delivery over wireless, fixed, or converged networks. As shown, the CN 130 can be a 5G CN (5GC) 131, a 4G CN (i.e., Evolved Packet Core, or EPC) 132, or an Other CN 133. For example, the Other CN 133 can be a 3G CN or a 2G CN.

The DN 140 is a digital network that can provide different Internet services and applications to the UE 110. The Internet services and applications can be access to World Wide Web (WWW), digital video, digital audio, cloud storage and server, the use of email and instant message (IM) applications, and the like. For example, the DN 140 can include an IMS, so that in a 4G system, the EPC 132 can be connected to the IMS and the UEs 110 in the 4G system can obtain an IMS voice service by registering to the IMS.

In operation, the UE 110 can connect to the CN 130 over a 3GPP access 121, or a non-3GPP access 122. Alternatively, the UE 110 can simultaneously connect to the CN 130 over the 3GPP access 121 and the non-3GPP access 122. Then, the UE 110 can obtain Internet services and applications from the DN 140 which is connected with the CN 130.

For 3GPP IMS-supported voice services, a voice-centric UE 110 can determine whether it can obtain an IMS voice service in the communication system 100 after receiving an indication from the CN 130. For example, in a 5G system 100, the UE 110 can receive an indication from the 5GC 131 that includes information of the IMS voice over packet switch (VoPS) capability per access type. Specifically, based on the 3GPP specifications, the 5GC 131 can send an IMS VoPS indicator to the UE 110, either through a 5G AN 120 or a Non-Access Stratum (NAS) connection. The first bit of the IMS VoPS indicator can indicate whether the IMS voice is supported or not over the 3GPP access 121 and the second bit of the IMS VoPS can indicate whether the IMS voice is supported or not over the non-3GPP access 122. According to the indication, the UE 110 can further perform the VDS.

In some examples, the UE 110 can receive the indication that the IMS VoPS session is supported over the 3GPP access 121. Then the UE 110 can perform the VDS by registering to the 5GC 131 over the 3GPP access 121. The UE 110 can further register to an IMS and use the 3GPP access 121 for the IMS voice service.

In some other examples, due to the VDM setting, the UE can receive the indication that the IMS VoPS session is not supported over the 3GPP access 121. The UE 110 can perform the VDS by reselecting a new RAT and connect to a second communication system, e.g., a 4G system, a 3G system or a 2G system. For example, the UE 110 can switch from the 5G system to a 4G system by reselecting a LTE AN 121 and use the LTE AN 121 for the IMS voice service. The switch from the 5G system to the 4G system can result in increased signaling overhead and the UE 110 in 4G system can obtain a lower data rate and a worse user experience.

Alternatively, the UE 110 can stay in the 5G system even when the IMS VoPS session is not supported over the 3GPP access 121, as long as the IMS VoPS session is supported over the non-3GPP access 122. Under this situation, the UE 110 can register to the 5GC 131 over the non-3GPP access 122 if the UE 110 is not yet registered. For example, the UE 110 can register to the 5GC 131 through a Wi-Fi AN 122 if the UE 110 is not yet registered. The UE 110 can further register to an IMS and use the Wi-Fi AN 122 for the IMS voice service, i.e., initiating the IMS voice service by using Wi-Fi calling (WFC).

In some other examples, due to the VDM setting, the UE 110 can perform the VDS by reselecting a new RAT to connect to a second communication system, e.g., a 4G system, a 3G system or a 2G system. The UE 110 can still switch back to the 5G system from the second communication system when the UE 110 registers to the 5GC over the non-3GPP access 122. For example, the UE 110 can switch from the 5G system to a 4G system due to the VDM. When the UE connects to the 4G system over the LTE AN 121, the UE 110 can try to register to the 5GC through the Wi-Fi AN 122 if the UE 110 is not yet registered. When the IMS VoPS session is supported over the Wi-Fi AN 122, the UE 110 can switch back to the 5G system from the 4G system.

Similarly, in a 4G system, when a UE 110 manually activates PS Data Off and IMS voice is not in the exempt service list, or LTE signal is too weak to support an IMS voice service, the IMS voice cannot be supported over the 3GPP access 121. Instead, the UE 110 can stay in the 4G system over the non-3GPP access 122. For example, the UE 110 can register to the EPC 132 over the Wi-Fi AN 122 if the UE 110 is not yet registered, and use WFC for the IMS voice service.

In addition, when the UE 110 stays in the 4G system over the non-3GPP access 122, the UE 110 can initiate a circuit switched fallback (CSFB) for a circuit switched (CS) voice service when the VDM is set to cellular, and the UE 110 can initiate a WFC for the IMS voice service when the VDM is set to Wi-Fi.

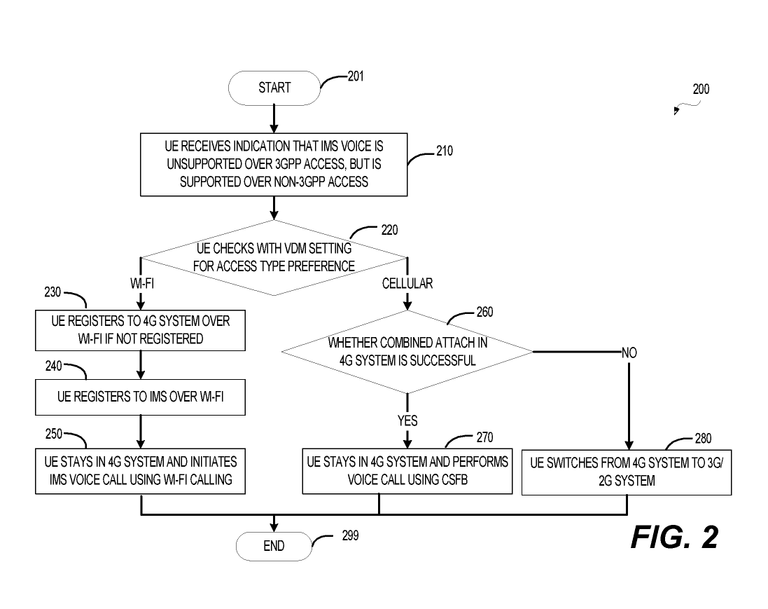

FIG. 2 shows a flowchart outlining an exemplary process 200 of voice domain selection in a 4G system according to an embodiment of the disclosure. The process 200 can be performed at the UE 110 which is connected to a first communication system and at least a second communication system. In the FIG. 2 example, the first communication system can be a 4G system and the second communication system can be selected from a 3G system and a 2G system. The 3GPP access 121 can be selected from a LTE AN, a GSM AN, and the like. The non-3GPP access 122 can be a Wi-Fi AN. The process 200 can start from 201 and proceed to 210.

At 210, the UE 110 can receive an indication that the IMS voice is not supported over the 3GPP access 121 in the 4G system, but is supported over the non-3GPP access 122 in the 4G system. There can be one or more reasons that cause the IMS voice not supported over the 3GPP access 121 in the 4G system. For example, when the UE 110 activates PS Data Off and the IMS voice is not in the exempt service list, the IMS voice cannot be supported over the 3GPP access 121 in the 4G system. This is because PS Data Off can disable all data services, except the most essential ones that are included in the exempt service list. Unfortunately, the IMS voice is not in the exempt service list, so that the UE 110 cannot obtain the IMS voice service over the 3GPP access 121 in the 4G system. Another exemplary reason can be a weak cellular signal (e.g., LTE signal) for the UE 110 in the 4G system. The weak cellular signal cannot support the IMS voice service since it cannot satisfy the quality of service (QoS) requirements of the IMS voice service. The UE 110 can further receive the indication that IMS voice is supported over the non-3GPP access 122 in the 4G system. For example, the UE 110 can receive the indication that Wi-Fi is available in the 4G system and the WFC is supported in the 4G system. The process can then proceed to 220.

At 220, the UE 110 can check with the VDM setting for the access type preference. For example, the VDM can select Wi-Fi as the access type or cellular as the access type. The process can then proceed to 230 when the VDM is set to select Wi-Fi and to 260 when the VDM is set to select cellular.

At 230, the UE 110 can register to the 4G system over the non-3GPP access 122 if the UE 110 is not yet registered. For example, the UE 110 can register to a Wi-Fi AN 122 if it is not yet registered and connect to an EPC 132 through the Wi-Fi AN 122. Therefore, the UE 110 can stay in the 4G system. The process can then proceed to 240.

At 240, the UE 110 can register to an IMS over the non-3GPP access 122. For example, the UE 110 can register to an IMS through the Wi-Fi AN 122. The process can then proceed to 250.

At 250, the UE 110 can stay in the 4G system and can further initiate a WFC to perform the IMS voice service. The process can then proceed to 299 and terminate.

Alternatively, at 260, the VDM is set to select cellular. The UE 110 can further check whether the combined attach in the 4G system is successful or not. The idea of combined attach is to simultaneously register to the 4G system and other communication systems, such as a 3G system or/and a 2G system. If the combined attach in the 4G system is successful, the process can proceed to 270. Otherwise, the process can proceed to 280.

At 270, the UE 110 can stay in the 4G system and can further initiate a CSFB to perform the voice service. Herein, the CSFB is a technology whereby the voice service can be delivered to the UE in the 4G system through the use of GSM or other circuit-switched network. For example, the UE 110 can initiate a circuit switched (CS) voice call for the voice service. The process can then proceed to 299 and terminate.

At 280, the UE 110 can switch from the 4G system to the 3G system or the 2G system. The process can then proceed to 299 and terminate.

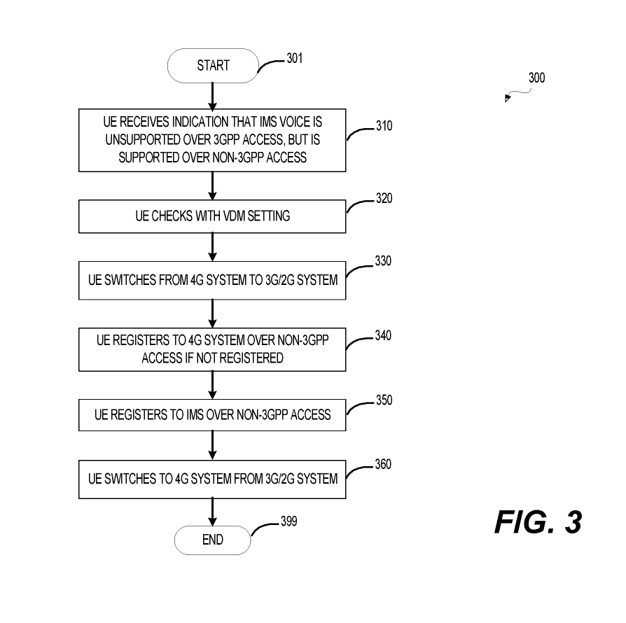

FIG. 3 shows a flowchart outlining another exemplary process 300 of voice domain selection in a 4G system according to an embodiment of the disclosure. The process 300 can be performed at the UE 110 which is connected to a first communication system and at least a second communication system. In the FIG. 3 example, the first communication system can be a 4G system and the second communication system can be selected from a 3G system and a 2G system. The 3GPP access 121 can be selected from a LTE AN, a GSM AN, and the like. The non-3GPP access 122 can be a Wi-Fi AN. The process 300 can start from 301 and proceed to 310.

At 310, the UE 110 can receive an indication that the IMS voice is not supported over the 3GPP access 121 in the 4G system, but is supported over the non-3GPP access 122 in the 4G system. There can be one or more reasons that cause the IMS voice not supported over the 3GPP access 121 in the 4G system. For example, when the UE 110 activates PS Data Off and the IMS voice is not in the exempt service list, the IMS voice cannot be supported over the 3GPP access 121 in the 4G system. This is because PS Data Off can disable all data services, except the most essential ones that are included in the exempt service list. Unfortunately, the IMS voice is not in the exempt service list, so that the UE 110 cannot obtain the IMS voice service over the 3GPP access 121 in the 4G system. Another exemplary reason can be a weak cellular signal (e.g., LTE signal) for the UE 110 in the 4G system. The weak cellular signal cannot support the IMS voice service since it cannot satisfy the quality of service (QoS) requirements of the IMS voice service. The UE 110 can further receive the indication that the IMS voice is supported over the non-3GPP access 122 in the 4G system. For example, the UE 110 can receive the indication that Wi-Fi is available and the WFC is supported in the 4G system. The process can then proceed to 320.

At 320, the UE 110 can check with the VDM setting for access type preference and decide which kind of access types can be selected. The process can then proceed to 330.

At 330, due to the VDM setting, the UE 110 can switch from the 4G system to the second communication system. Even when the UE 110 can receive the indication that IMS voice is supported over the non-3GPP access 122 in the 4G system, the UE 110 can still follow the VDM setting and switch from the 4G system to the second communication system. For example, the UE 110 can switch from the 4G system to a 3G system or a 2G system by selecting and engaging with an Other CN 133. Herein, the Other CN 133 can be a 3G CN or a 2G CN. The process can then proceed to 340.

At 340, due to the availability of the non-3GPP access 122, the UE 110 can register to the 4G system over the non-3GPP access 122 if the UE 110 is not yet registered. For example, the UE 110 can register to a Wi-Fi AN 122 and connect to an EPC 132 through the Wi-Fi AN 122 if the UE 110 is not yet registered. The process can then proceed to 350.

At 350, the UE 110 can register to an IMS over the non-3GPP access 122. For example, the UE 110 can register to an IMS over the Wi-Fi AN 122 and further register to a WFC. The process can then proceed to 360.

At 360, the UE 110 can switch to the 4G system from the 3G system or the 2G system after the WFC registration is done. The process can then proceed to 399 and terminate.

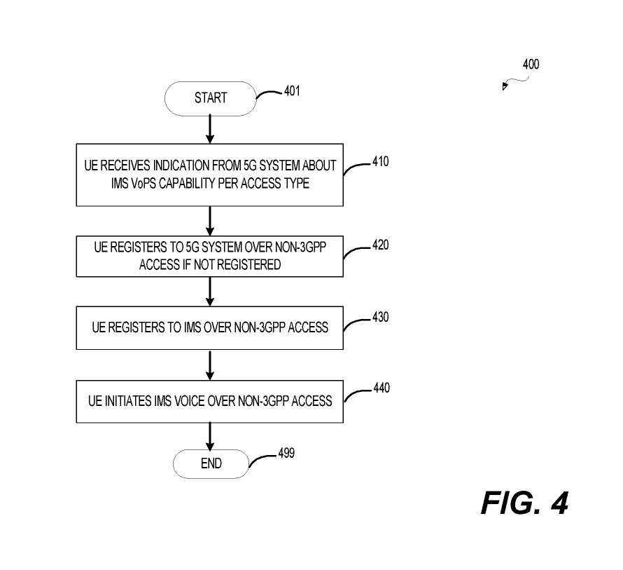

FIG. 4 shows a flowchart outlining an exemplary process 400 of voice domain selection in a 5G system according to an embodiment of the disclosure. The process 400 can be performed at the UE 110 which is connected to a first communication system and at least a second communication system. In the FIG. 4 example, the first communication system can be a 5G system and the second communication system can be selected from a 4G system, a 3G system, and a 2G system. The 3GPP access 121 can be selected from a 5G NR AN, a LTE AN, a GSM AN, and the like. The non-3GPP access 122 can be a Wi-Fi AN. The process 400 can start from 401 and proceed to 410.

At 410, the UE 110 can receive an indication about the IMS VoPS capability per access type. According to the current 3GPP specifications, the UE 110 can communicate with the 5GC 131 through the 5G AN 120 or through a Non-Access Stratum (NAS) connection. Then the UE 110 can receive a 5GS Mobility Management (5GMM) message that includes an IMS VoPS indicator, wherein the first bit can indicate the support of the IMS VoPS session over 3GPP access 121 and the second bit can indicate the support of the IMS VoPS session over non-3GPP access 122. For example, the UE 110 can receive the indication that the IMS VoPS session is not support over the 3GPP access 121, but is supported over the non-3GPP access 122. The process can then proceed to 420.

At 420, the UE 110 can register to the 5G system over the non-3GPP access 122 if it is not yet registered. For example, the UE 110 can register to a Wi-Fi AN 122 and connect to a 5GC 131 through the Wi-Fi AN 122 if the UE 110 is not yet registered. Therefore, the UE 110 can stay in the 5G system. The process can then proceed to 430.

At 430, the UE 110 can register to an IMS over the non-3GPP access 122. For example, the UE 110 can register to an IMS through the Wi-Fi AN 122. The process can then proceed to 440.

At 440, the UE 110 can initiate an IMS VoPS session over the non-3GPP access 122 in the 5G system. The process can then proceed to 499 and terminate.

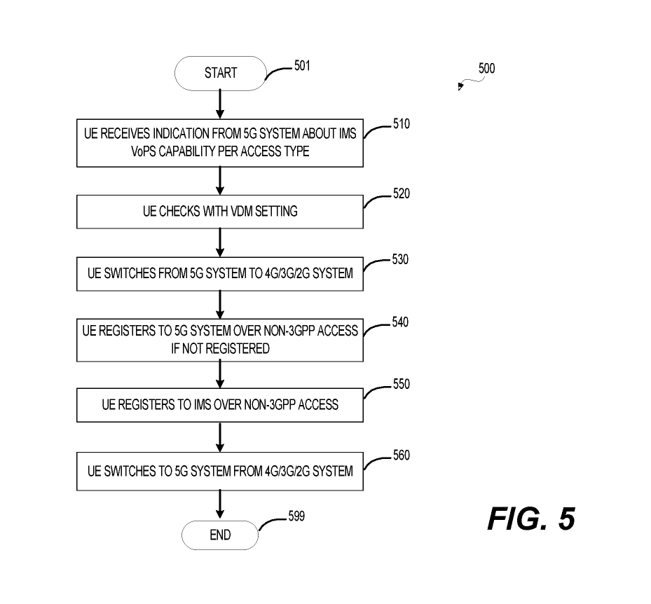

FIG. 5 shows a flowchart outlining another exemplary process 500 of voice domain selection in a 5G system according to an embodiment of the disclosure. The process 500 can be performed at the UE 110 which is connected to a first communication system and at least a second communication system. In the FIG. 5 example, the first communication system can be a 5G system and the second communication system can be selected from a 4G system, a 3G system, and a 2G system. The 3GPP access 121 can be selected from a 5G NR AN, a LTE AN, a GSM AN, and the like. The non-3GPP access 122 can be a Wi-Fi AN. The process 500 can start from 501 and proceed to 510.

At 510, the UE 110 can receive an indication about the IMS VoPS capability per access type. According to the current 3GPP specifications, the UE 110 can communicate with the 5GC 131 through the 5G AN 120 or through a NAS connection. Then the UE 110 can receive a 5GMM message that includes an IMS VoPS indicator, wherein the first bit can indicate the support of the IMS VoPS session over 3GPP access 121 and the second bit can indicate the support of the IMS VoPS session over non-3GPP access 122. For example, the UE 110 can receive the indication that IMS VoPS session is not support over the 3GPP access 121, but is supported over the non-3GPP access 122. The process can then proceed to 520.

At 520, the UE 110 can check with the VDM setting for access type preference and decide which kind of access types can be selected. The process can then proceed to 530.

At 530, due to the VDM setting, the UE 110 can switch from the 5G system to the second communication system. Even when the UE 110 can receive the indication that the IMS VoPS session is supported over the non-3GPP access 122 in the 5G system, the UE 110 can still follow the VDM setting and switch from the 5G system to the second communication system. For example, the UE 110 can switch from the 5G system to a 4G system, a 3G system, or a 2G system by selecting and engaging with an EPC 132 or an Other CN 133. Herein, the Other CN 133 can be a 3G CN or a 2G CN. The process can then proceed to 540.

At 540, due to the availability of non-3GPP access 122, the UE 110 can register to the 5G system over the non-3GPP access 122 if it is not yet registered. For example, the UE 110 can register to a Wi-Fi AN 122 and connect to a 5GC 131 through the Wi-Fi AN 122 if the UE 110 is not yet registered. The process can then proceed to 550.

At 550, the UE 110 can register to an IMS over the non-3GPP access 122. For example, the UE 110 can register to an IMS over the Wi-Fi AN 122. The process can then proceed to 560.

At 560, the UE 110 can switch to the 5G system from the 4G system, the 3G system, or the 2G system when the IMS VoPS session is supported over the non-3GPP access 122. The process can then proceed to 599 and terminate.

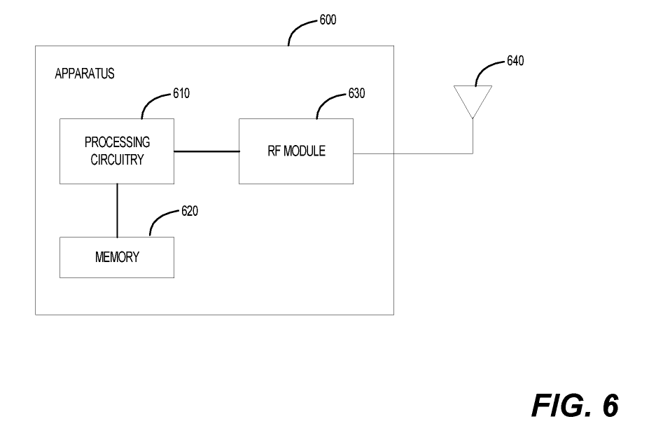

FIG. 6 shows an exemplary apparatus 600 according to embodiments of the disclosure. The apparatus 600 can be configured to perform various functions in accordance with one or more embodiments or examples described herein. Thus, the apparatus 600 can provide means for implementation of techniques, processes, functions, components, systems described herein. For example, the apparatus 600 can be used to implement functions of the UE 110 in various embodiments and examples described herein. The apparatus 600 can be a general purpose computer in some embodiments, and can be a device including specially designed circuits to implement various functions, components, or processes described herein in other embodiments. The apparatus 600 can include processing circuitry 610, a memory 620, a radio frequency (RF) module 630, and an antenna 640.

In various examples, the processing circuitry 610 can include circuitry configured to perform the functions and processes described herein in combination with software or without software. In various examples, the processing circuitry can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 610 can be a central processing unit (CPU) configured to execute program instructions to perform various functions and processes described herein. Accordingly, the memory 620 can be configured to store program instructions. The processing circuitry 610, when executing the program instructions, can perform the functions and processes. The memory 620 can further store other programs or data, such as operating systems, application programs, and the like. The memory can include transitory or non-transitory storage medium. The memory 620 can include a read only memory (ROM), a random access memory (RAM), a flash memory, a solid state memory, a hard disk drive, an optical disk drive, and the like.

The RF module 630 receives processed data signal from the processing circuitry 610 and transmits the signal in a beam-formed wireless communication network via an antenna 640, or vice versa. The RF module 630 can include a digital to analog convertor (DAC), an analog to digital converter (ADC), a frequency up convertor, a frequency down converter, filters, and amplifiers for reception and transmission operations. The RF module 630 can include multi-antenna circuitry (e.g., analog signal phase/amplitude control units) for beamforming operations. The antenna 640 can include one or more antenna arrays.

The apparatus 600 can optionally include other components, such as input and output devices, additional or signal processing circuitry, and the like. Accordingly, the apparatus 600 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. User equipment, comprising processing circuitry that is configured to:
receive an indication that an internet protocol (IP) multimedia core network subsystem (IMS) voice is unsupported over a 3GPP access, but is supported over a non-3GPP access in a first communication system;
register to an IMS via the non-3GPP access in the first communication system; and
perform the IMS voice over the non-3GPP access in the first communication system.

2. The user equipment of claim 1, wherein the processing circuitry is further configured to:
switch to a second communication system when voice domain management (VDM) is set to the second communication system;
register to the IMS via the non-3GPP access in the first communication system; and
switch to the first communication system from the second communication system.

3. The user equipment of claim 2, wherein the first communication system is a fifth generation (5G) system and the second communication system is one of:
a fourth generation (4G) system;
a third generation (3G) system; or
a second generation (2G) system.

4. The user equipment of claim 2, wherein the first communication system is a fourth generation (4G) system and the second communication system is one of:
a third generation (3G) system; or
a second generation (2G) system.

5. The user equipment of claim 1, wherein when the first communication system is a fifth generation (5G) system, the processing circuitry is further configured to:
remain in the 5G system;
register to the IMS over the non-3GPP access in the 5G system; and
perform an IMS voice over packet switch (VoPS) session over the non-3GPP access in the 5G system.

6. The user equipment of claim 1, wherein when the first communication system is a fourth generation (4G) system, the processing circuitry is further configured to:
remain in the 4G system;
register to the IMS over the non-3GPP access in the 4G system; and
perform the IMS voice over the non-3GPP access in the 4G system.

7. The user equipment of claim 7, wherein the processing circuitry performing the IMS voice over the non-3GPP access in the 4G system, is further configured to:
select a Wi-Fi calling (WFC) for the IMS voice call when the voice domain management (VDM) is set to Wi-Fi; and
select a circuit switched fallback (CSFB) for a circuit switched (CS) voice call when the voice domain management (VDM) is set to cellular.

8. A method of voice domain selection, comprising:
receiving, by a processing circuitry of a user equipment (UE), an indication that an internet protocol (IP) multimedia core network subsystem (IMS) voice is unsupported over a 3GPP access, but is supported over a non-3GPP access in a first communication system;
registering to an IMS via the non-3GPP access in the first communication system; and
performing the IMS voice over the non-3GPP access in the first communication system.

9. The method of claim 8, further comprising:
switching to a second communication system when voice domain management (VDM) is set to the second communication system;
registering to the IMS via the non-3GPP access in the first communication system; and
switching to the first communication system from the second communication system.

10. The method of claim 9, wherein the first communication system is a fifth generation (5G) system and the second communication system is one of:
a fourth generation (4G) system;
a third generation (3G) system; or
a second generation (2G) system.

11. The method of claim 9, wherein the first communication system is a fourth generation (4G) system and the second communication system is one of:
a third generation (3G) system; or
a second generation (2G) system.

12. The method of claim 8, when the first communication system is a fifth generation (5G) system, further comprising:
remaining in the 5G system;
registering to the IMS over the non-3GPP access in the 5G system; and
perform an IMS voice over packet switch (VoPS) session over the non-3GPP access in the 5G system.

13. The method of claim 8, when the first communication system is a fourth generation (4G) system, further comprising:
remaining in the 4G system;
registering to the IMS over the non-3GPP access in the 4G system; and
performing the IMS voice over the non-3GPP access in the 4G system.

14. The method of claim 13, wherein performing the IMS voice over the non-3GPP access in the 4G system, further comprising:
selecting a Wi-Fi calling (WFC) for the IMS voice call when the voice domain management (VDM) is set to WiFi; and
selecting a circuit switched fallback (CSFB) for a circuit switched (CS) voice call when the voice domain management (VDM) is set to cellular.

15. A non-transitory computer readable medium storing instructions which, when executed by a processor, cause the processor to perform the steps of:
receiving an indication that an internet protocol (IP) multimedia core network subsystem (IMS) voice is unsupported over a 3GPP access, but is supported over a non-3GPP access in a first communication system;
registering to an IMS via the non-3GPP access in the first communication system; and
performing the IMS voice over the non-3GPP access in the first communication system.

16. The non-transitory computer readable medium of claim 15, wherein the instructions being executed by a processor, further cause the processor to perform the steps of:
switching to a second communication system when voice domain management (VDM) is set to the second communication system;
registering to the IMS via the non-3GPP access in the first communication system; and
switching to the first communication system from the second communication system.

17. The non-transitory computer readable medium of claim 15, wherein the instructions being executed by a processor when the first communication system is a fifth generation (5G) system, further cause the processor to perform the steps of:
remaining in the 5G system;
registering to the IMS over the non-3GPP access in the 5G system; and
performing an IMS voice over packet switch (VoPS) session over the non-3GPP access in the 5G system.

18. The non-transitory computer readable medium of claim 15, wherein the instructions being executed by a processor when the first communication system is a fourth generation (4G) system, further cause the processor to perform the steps of:
remaining in the 4G system;
registering to the IMS over the non-3GPP access in the 4G system; and
performing the IMS voice over the non-3GPP access in the 4G system.

19. The non-transitory computer readable medium of claim 18, wherein the instructions being executed by a processor, further cause the processor to perform the steps of:
selecting a Wi-Fi calling (WFC) for the IMS voice call when the voice domain management (VDM) is set to Wi-Fi; and
selecting a circuit switched fallback (CSFB) for a circuit switched (CS) voice call when the voice domain management (VDM) is set to cellular.
